(19) United States
(12) Patent Application Publication
(10) Pub. No.: US 2012/0321931 A1
(43) Pub. Date: Dec. 20, 2012

(54) SECONDARY BATTERY

(75) Inventor: Chang-Bum AHN, Yongin-si (KR)

(73) Assignee: Samsung SDI Co., Ltd., Yongin-si (KR)

(21) Appl. No.: 13/475,783

(22) Filed: May 18, 2012

(30) Foreign Application Priority Data
Jun. 15, 2011 (KR) 10-2011-0057950

(51) Int. Cl. H01M 2/14

(52) U.S. Cl. 429/144

(57) ABSTRACT

A secondary battery includes at least one first electrode plate, at least one second electrode plate and separators. The first electrode plate has a first active material layer intermittently coated in the length direction thereof and a first non-coating portion on which the first active material layer is not coated. The first non-coating portion is folded. The second electrode plate is alternately positioned with the first electrode plate, and has a second active material layer intermittently coated in the length direction thereof and a second non-coating portion on which the second active material layer is not coated. The second non-coating portion is folded. The separators are positioned between the respective first and second electrode plates. The secondary battery further includes first and second electrode tabs that respectively clamp at least one of the first non-coating portions and at least one of the second non-coating portions.

### CROSS-REFERENCE TO RELATED APPLICATIONS

This application claims priority to and the benefit of Korean Patent Application No. 10-2011-0057950, filed on Jun. 15, 2011, in the Korean Intellectual Property Office, the entire content of which is incorporated herein by reference.

### BACKGROUND

1. Field

An aspect of the present embodiments relates to a secondary battery, and more particularly, to a secondary battery capable of being more simply manufactured by decreasing the number of processes.

2. Description of the Related Technology

In a secondary battery, a wound-type electrode assembly is formed by winding a positive electrode plate, a negative electrode assembly and a separator interposed therebetween. In this instance, a positive electrode tab and a negative electrode tab are thermally bonded to non-coating portions of the positive and negative electrode plates, respectively.

A stacked-type secondary battery may be formed by sequentially stacking a plurality of positive electrode plates, a plurality of negative electrode plates and a plurality of separators interposed therebetween. In this instance, positive and negative tabs are extracted from the positive and negative electrode plates, respectively.

### SUMMARY

Embodiments provide a secondary battery capable of omitting a process of thermally bonding an electrode tab to an electrode plate by forming the electrode tab to clamp a non-coating portion of the electrode plate in the implementation of a medium- and large-sized battery.

According to an aspect of the present embodiments, there is provided a secondary battery including: at least one first electrode plate having a first active material layer intermittently coated in the length direction thereof and a first non-coating portion on which the first active material layer is not coated, wherein the first non-coating portion is folded; at least one second electrode plate alternately positioned with the first electrode plate, the second electrode plate having a second active material layer intermittently coated in the length direction thereof and a second non-coating portion on which the second active material layer is not coated, wherein the second non-coating portion is folded; and separators positioned between the respective first and second electrode plates, wherein the secondary battery further includes a first electrode tab that clamps at least one of the first non-coating portions and a second electrode tab that clamps at least one of the second non-coating portions.

The first electrode tab may comprise aluminum (Al), and the second electrode tab may comprise nickel (Ni).

The first and second electrode tabs may clamp the first and second non-coating portions in folded states with widths ranging from 40 to 95% with respect to the widths of the first and second non-coating portions, respectively.

The first and second electrode tabs may be formed in a ‘C’ or ‘ [symbol] ’ shape.

The first and second electrode tabs may be formed to have a thickness ranging from 0.5 to 1.0 mm.

The first and second electrode tabs may be clamped to the respective first and second non-coating portions by applying pressure thereto.

The first electrode plate may have a positive polarity, and the second electrode plate may have a negative polarity. The second electrode plate may be formed larger than the first electrode plate.

In the at least one first electrode plate and the at least one second electrode plate, the difference in length between the second electrode plate and the first electrode plate positioned at the innermost position may be grater than that in length between the second electrode plate and the first electrode plate positioned at the outermost position.

The separator may be formed in zigzag, and may be inserted between the first and second electrode plates from a direction perpendicular to the length directions of the first and second electrode plates.

The separator may be formed by coating an inorganic substance on the first and second electrode plates.

The separator or a taping member may be further formed on an outermost surface of each of the first and second electrode plates.

The secondary battery may further include a housing that accommodates the first and second electrode plates respectively clamped by the first and second electrode tabs and the separator.

The housing may comprise polypropylene (PP) or polyethylene terephthalate (PET).

First and second auxiliary terminals may be further formed between the first electrode tab and the first electrode plate and between the second electrode tab and the second electrode plate, respectively, and the first and second auxiliary terminals may be electrically connected to first and second electrode leads, respectively.

The first and second electrode tabs may be electrically connected to the first and second auxiliary terminals through welding, respectively.

The first and second auxiliary terminals may be electrically connected to the first and second electrode leads through screw bonding or welding, respectively.

The secondary battery may be applied medium- and large-sized batteries of 50 Ah or more.

According to the present embodiments, it is possible to omit a process of aligning electrode plates and to omit a process of bonding electrode tabs to the respective electrode plates by simplifying the electrode tabs as clamps. Accordingly, the number of processes is decreased, so that a high-power, medium- or large-sized battery can be more simply manufactured.

Further, productivity can be improved by decreasing the number of process. Since there occurs no problem of alignment between the electrode plates, a short circuit between the electrode plates is prevented, thereby improving safety.

### BRIEF DESCRIPTION OF THE DRAWINGS

The accompanying drawings, together with the specification, illustrate exemplary embodiments, and, together with the description, serve to explain the principles of the present embodiments.

FIG. 1 is an assembled perspective view showing an electrode assembly according to an embodiment.

FIG. 2 is a perspective view showing a coating form of an electrode plate according to the embodiment.

FIG. 3 is an exploded perspective view showing a state that positive electrode plates, negative electrode plates and separators are assembled together according to embodiment.

FIG. 4 is a perspective view showing an electrode assembly according to another embodiment.

FIG. 5 is a perspective view showing an electrode tab according to still another embodiment.

FIG. 6 is a plan view for comparing sizes of positive and negative electrode plates according to the present embodiments.

FIG. 7 is a perspective view showing a secondary battery including a housing according to the present embodiments.

FIG. 8A is a cross-sectional view taken along line C-C′ of FIG. 7.

FIG. 8B is another cross-sectional view taken along the line C-C′ of FIG. 7.

FIG. 9A is a sectional view taken along line D-D′ of FIG. 7.

FIG. 9B is a sectional view taken along the line D-D′ of FIG. 7.

### DETAILED DESCRIPTION

In the following detailed description, only certain exemplary embodiments have been shown and described, simply by way of illustration. As those skilled in the art would realize, the described embodiments may be modified in various different ways, all without departing from the spirit or scope of the present embodiments. Accordingly, the drawings and description are to be regarded as illustrative in nature and not restrictive. In addition, when an element is referred to as being “on” another element, it can be directly on the other element or be indirectly on the another element with one or more intervening elements interposed therebetween. Also, when an element is referred to as being “connected to” another element, it can be directly connected to the other element or be indirectly connected to the other element with one or more intervening elements interposed therebetween. Hereinafter, like reference numerals refer to like elements. In the drawings, the thickness or size of layers are exaggerated for clarity and not necessarily drawn to scale.

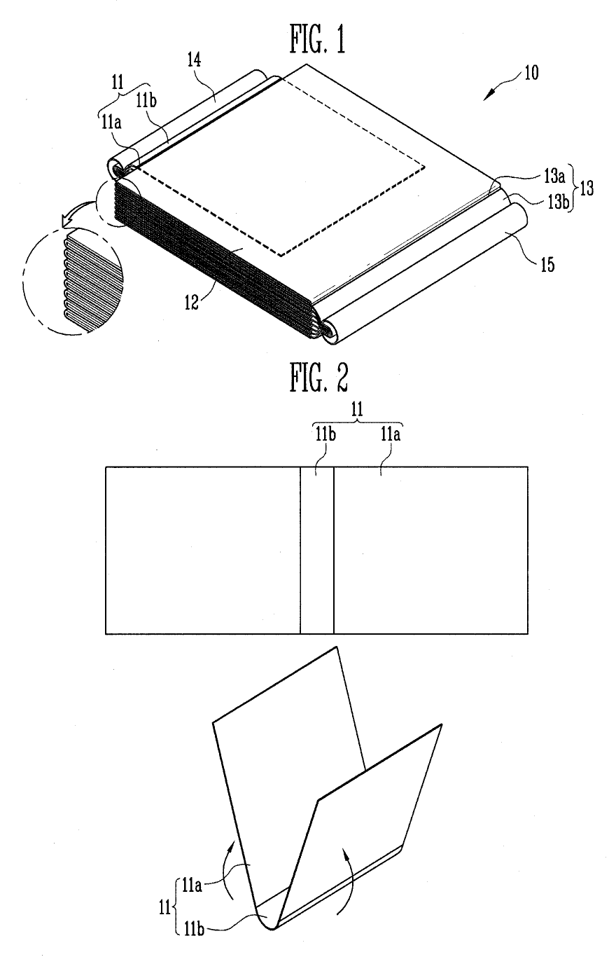

FIG. 1 is an assembled perspective view showing an electrode assembly according to an embodiment. FIG. 2 is a perspective view showing a coating form of an electrode plate according to the embodiment.

In a general secondary battery, an error may occur in the process of aligning electrode plates of a stacked-type or wound-type electrode assembly. Particularly, in the case of the stacked-type electrode assembly, a plurality of positive electrode plates and a plurality of negative electrode plates are aligned. Therefore, in a case where a problem of alignment occurs in the manufacture of a medium- or large-sized battery for obtaining high power, the number of process may be increased. In a case where the alignment is wrong, a short circuit may occur while positive and negative electrode plates come in contact with each other. Therefore, in order to improve the productivity and safety of the wound-type or stacked type electrode assembly, it is required to perform a more precise alignment.

In order to improve the alignment process described above, an embodiment is illustrated in FIGS. 1 and 2.

Referring to FIGS. 1 and 2, the electrode assembly 10 according to this embodiment includes positive electrode plates 11, negative electrode plates 13, separators 12 and positive and negative electrode tabs 14 and 15.

Each of the positive electrode plates 11 includes positive electrode active material layers 11a and a positive electrode non-coating portion 11b positioned in the middle of the length direction thereof. The positive electrode plates 11 are formed by overlapping the plurality of the positive electrode active material layers 11a in the state that the positive electrode non-coating portions 11b are folded. Each of the negative electrode plate 13 includes negative electrode active material layers 13a and a negative electrode non-coating portion 13b positioned in the middle of the length direction thereof. The negative electrode plates 13 are formed by overlapping the plurality of the negative electrode active material layers 13a in the state that the negative electrode non-coating portions 13b are folded. Preferably, each of the plurality of positive electrode plates 11 and the plurality of negative electrode plates 13 has one side folded in shape of a book and the other side formed to be opened.

The positive and negative electrode plates 11 and 13 are alternately positioned. For example, the other side opposite to the negative electrode non-coating portion 13b of the negative electrode plate 13 is interposed to the other side opposite to the positive electrode non-coating portion 11b of the positive electrode plate 11 between the positive electrode plates 11. The separators 12 are positioned between the respective positive and negative electrode plates 11 and 13. In this instance, the separators 12 may be formed in zigzag, so as to be inserted in a direction perpendicular to the length directions of the positive and negative electrode plates 11 and 13.

In some embodiments, the separator 12 may be further formed to extend on an electrode plate positioned at the outermost position of the positive or negative electrode plates 11 or 13. Alternatively, although not shown in FIG. 1, the separators 12 are positioned only between the respective positive and negative electrode plates 11 and 13, and a taping member may be further formed on the electrode plate positioned at the outermost position of the positive or negative electrode plates 11 or 13. Accordingly, it is possible to prevent the positive or negative electrode plate 11 or 13 from being exposed to the outside of the electrode assembly 10.

A positive electrode tab 14 and a negative electrode tab 15 may be clamped to the positive and negative electrode non-coating portions 11b and 13b, respectively. In this instance, the positive and negative electrode tabs 14 and 15 may be formed in a ‘C’ shape. The positive and negative electrode tabs 14 and 15 may be clamped to the respective positive and negative electrode non-coating portions 11b and 13b by applying pressure to the electrode assembly 10 in the state that the positive and negative electrode non-coating portions 11b and 13b are inserted into the respective positive and negative electrode tabs 14 and 15.

Here, the positive electrode tab 14 may comprise aluminum (Al), and the negative electrode tab 15 may comprise nickel (Ni). The positive and negative electrode tabs 14 and 15 are clamped to the respective positive and negative electrode plates 11 and 13, so that it is possible to reduce the number of bonding processes performed when forming conventional electrode tabs.

Hereinafter, the positive electrode plate 11, the negative electrode plate 13 and the separator 12 according to the present embodiments will be briefly described.

The positive electrode plate 11 includes a positive electrode collector having excellent conductivity and the positive electrode active material layer 11a formed on at least one surface of the positive electrode collector. In this instance, the positive electrode plate 11 further includes the positive electrode non-coating portion 11b that exposes the positive electrode collector in the middle of the length direction of the positive electrode plate 11. Aluminum (Al) having excellent conductivity is generally used as the positive electrode collector. The positive electrode active material layer 11a is formed by coating a positive slurry on at least one surface of the positive electrode collector. In the positive slurry, a positive electrode active material, a conducting agent and a positive electrode binder are mixed together.

Here, the positive electrode active material generates electrons by participating in a positive electrode chemical reaction of a lithium secondary battery, and the conducting agent may transfer the electrons generated in the positive electrode active material to the positive electrode collector. The positive electrode binder binds the positive electrode active material and the conducting agent to each other so as to maintain the mechanical strength of the positive electrode plate 11.

Although, lithium complex metal oxides such as LiCoO₂, LiMn₂O₄, LiNiO₂, LiNi-xCoxO₂(0<x>1) and LiMnO₂ may be used as the positive electrode active material, the present embodiments are not limited thereto.

The negative electrode plate 13 includes a negative electrode collector made of a conductive metal sheet and the negative electrode active material layer 13a coated on at least one surface of the negative electrode collector. In this instance, the negative electrode plate 13 further includes the negative electrode non-coating portion 11b that exposes the negative electrode collector in the middle of the length direction of the negative electrode plate 13. The negative electrode active material layer 13a includes a negative electrode active material and a negative electrode binder that binds the negative electrode active material to the negative electrode collector.

Here, the negative electrode collector may comprise copper (Cu) or nickel (Ni). Although any one of hard carbon, soft carbon and graphite may be mainly used as the negative electrode active material, the present embodiments are not limited thereto.

The separator 12 is interposed between the positive and negative electrode plates 11 and 13, and an insulative thin film having high ion transmittance and mechanical strength is used as the separator 12. The separator 12 prevents an electrical short circuit between positive and negative electrodes in the charge/discharge of a battery, and enables only the movement of lithium ions. In order to prevent the phenomenon that circumferences of the positive and negative electrode plates 11 and 13 are short-circuited, the width and length of the separator 12 may be formed slightly greater than those of each of the positive and negative electrode plates 11 and 13.

The separator 12 may comprise a micro-porous material in which the movement of lithium ions is possible. For example, the separator 12 may comprise polyethylene (PE), polypropylene (PP), polyolefin resin or derivative thereof, which has a plurality of micro-pores. However, the present embodiments are not limited thereto.

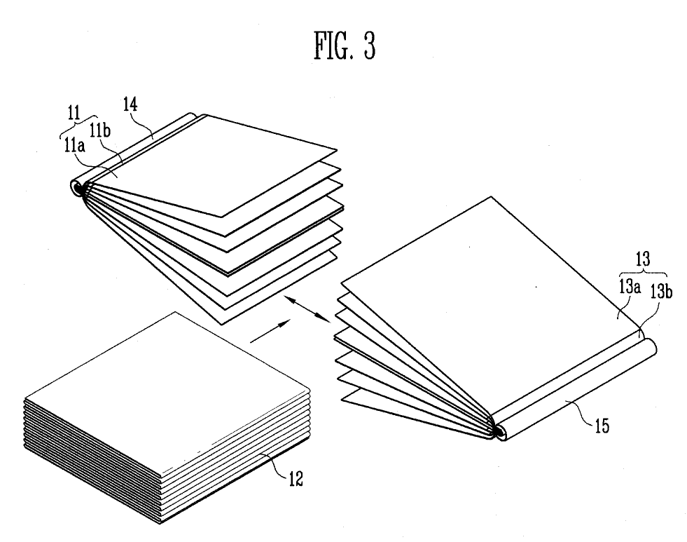

FIG. 3 is an exploded perspective view showing a state that the positive electrode plates, the negative electrode plates and the separators are assembled together according to embodiment.

Referring to FIG. 3, the plurality of positive electrode plates 11 are overlapped in the state that the positive electrode non-coating portion 11b formed in the middle of the length direction of each of the positive electrode plates 11 is folded. The plurality of positive electrode plates 11 are clamped by the positive electrode tab 14. The plurality of negative electrode plates 13 are overlapped in the state that the negative electrode non-coating portion 13b formed in the middle of the length direction of each of the negative electrode plates 13 is folded. The plurality of negative electrode plates 13 are clamped by the negative electrode tab 15.

The plurality of positive electrode plates 11 and the plurality of negative electrode plates 13 are positioned in the state that the other sides of the positive and negative electrode plates 11 and 13 face each other so that they are alternately formed. For example, the opened side of the negative electrode plate 13, opposite to the negative electrode non-coating portion 13b, is positioned toward the opened side of the positive electrode plate 11, opposite to the positive electrode non-coating portion 11b. Here, the negative electrode plate 13 may be formed larger than the positive electrode plate 11. Accordingly, the portion at which the positive and negative electrode plates 11 and 13 are misaligned can be designed to have a large margin.

If the areas at which the positive and negative electrode tabs 14 and 15 are fastened to the respective positive and negative electrode non-coating portions 11b and 13b are decreased, the positive and negative electrode tabs 14 and 15 may be separated from the respective positive and negative electrode non-coating portions 11b and 13b. If the positive and negative electrode tabs 14 and 15 are overlapped with portions of the respective positive and negative electrode active material layers 11a and 13a over the positive and negative electrode non-coating portions 11b and 13b, the positive and negative electrode active material layers 11a and 13a may be damaged.

More specifically, the positive or negative electrode tab 14 or 15 may be clamped to the positive or negative electrode non-coating portion 11b or 13b in a folded state with a width ranging from 40 to 95% with respect to the width of the positive or negative electrode non-coating portion 11b or 13b. The width of the positive or negative electrode non-coating portion 11b or 13b in the folded state is greater than the internal width of the positive or negative electrode tab 14 or 15 clamped to the positive or negative electrode non-coating portion 11b or 13b. In a case where the positive or negative electrode tab 14 or 15 is clamped to the positive or negative electrode non-coating portion 11b or 13b in the folded state with a width of below 40% with respect to the width of the positive or negative electrode non-coating portion 11b or 13b, the positive or negative electrode plate 11 or 13 positioned at the innermost position of the positive or negative electrode plates 11 or 13 may not be clamped to the positive or negative electrode non-coating portion 11b or 13b. In a case where the positive or negative electrode tab 14 or 15 is clamped to the positive or negative electrode non-coating portion 11b or 13b in the folded state with a width of over 95% with respect to the width of the positive or negative electrode non-coating portion 11b or 13b, the positive or negative electrode tab 14 or 15 is clamped to the positive or negative electrode active material layer 11a or 13a, and therefore, the positive or negative electrode active material layer 11a or 13a may be damaged.

Moreover, the positive and negative electrode tabs 14 and 15 may be formed to have a thickness ranging from 0.5 to 1.0 mm. If the positive and negative electrode tabs 14 and 15 are formed to have a thickness smaller than 0.5 mm or greater than 1.0 mm, the internal space index of the secondary battery may be decreased, and there may occur a problem in that the electrode assembly is positioned in the inside of a housing.

After the positive and negative electrode plates 11 and 13 are formed to be alternately positioned, the separators 12 formed in zigzag may be inserted between the respective positive and negative electrode plates 11 and 13.

To this end, the separator 12 is inserted between the positive and negative electrode plates 11 and 13 from a direction perpendicular to the length directions of the positive and negative electrode plates 11 and 13 in the state that the positive and negative electrode plates 11 and 13 are overlapped with each other. In this instance, the separator 12 may be formed to cover the outermost surface of the electrode plate 11.

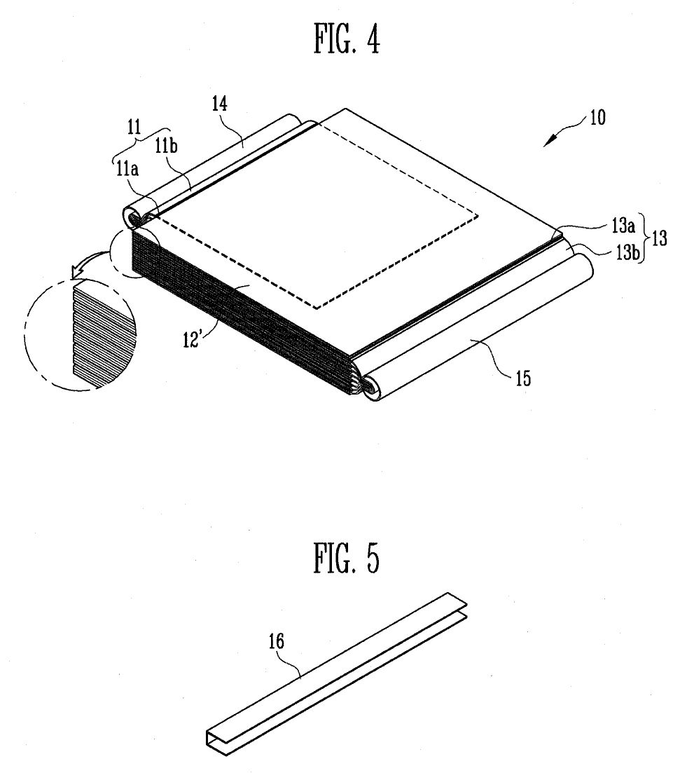

FIG. 4 is a perspective view showing an electrode assembly according to another embodiment.

Referring to FIG. 4, in the electrode assembly according to this embodiment, separators 12′ may be formed by coating an inorganic substance on the positive and negative electrode plates 11 and 13. The positive and negative electrode active material layers 11a and 13a are formed on the respective positive and negative electrode plates 11 and 13, and the inorganic substance is then coated on the positive and negative electrode plates 11 and 13. The positive and negative electrode plates 11 and 13 are alternately positioned.

In some embodiments, the separator 12 may include at least one selected from the group consisting of polypropylene, polyethylene, polyethylene terephthalate and ceramic.

FIG. 5 is a perspective view showing an electrode tab according to still another embodiment.

Referring to FIG. 5, the electrode tab 16 according to this embodiment may be formed in a ‘ [symbol] ’ shape. The ‘ [symbol] ’-shaped electrode tab 16 can more effectively clamp an electrode plate than the ‘C’-shaped electrode tabs 14 and 15 of the aforementioned embodiment. Although the ‘ [symbol] ’-shaped electrode tab 16 and the ‘C’-shaped electrode tab have the same height, the ‘ [symbol] ’-shaped electrode tab 16 has an entrance and internal space wider than the ‘C’-shaped electrode tab. Thus, the ‘ [symbol] ’-shaped electrode tab 16 can clamp a thicker electrode plate as compared with the ‘C’-shaped electrode tab.

In the present embodiments, the shape of the electrode tab is not limited. It will be apparent that the electrode tab may be formed in various shapes capable of clamping a plurality of electrode plates.

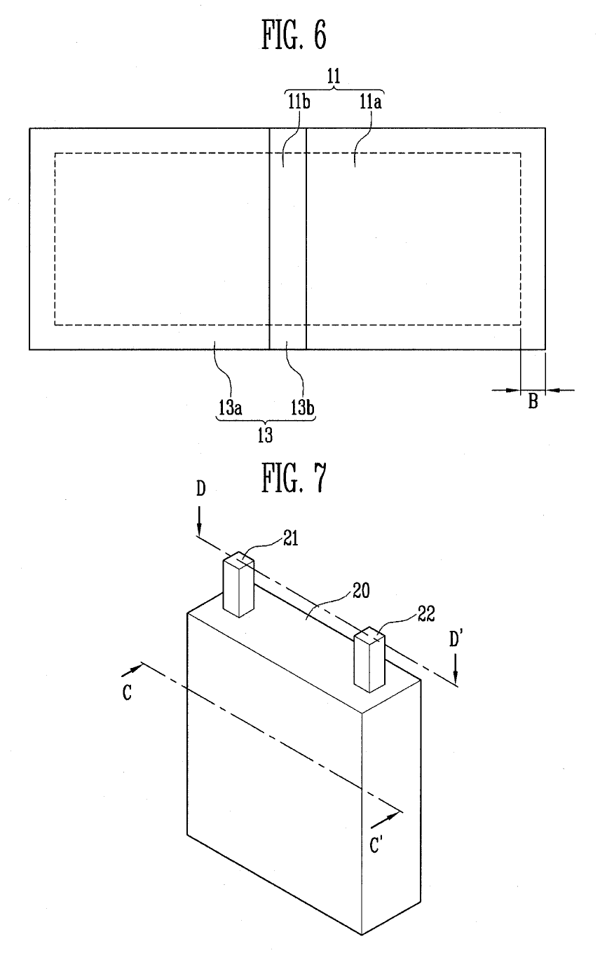

FIG. 6 is a plan view for comparing sizes of the positive and negative electrode plates according to the present embodiments.

Referring to FIG. 6, the negative electrode plate 13 may be formed larger than the positive electrode plate 11. For example, the negative electrode plate 13 may be formed to have a size extended by 5 to 10 mm from each sides of the positive electrode plate 11. Accordingly, in a case where the non-coating portions 13b of the plurality of negative electrode plates 13 and the non-coating portions 11b of the plurality of positive electrode plates 11 are folded, the margin of alignment is increased, and thus it is sufficient that the alignment is not minutely set.

If ‘B’ is less than 5 mm, the margin of the alignment is decreased because a significant difference hardly exists between the sizes of the electrode plates. Therefore, it is meaningless that the negative electrode plate 13 is formed to have a larger size than that of the positive electrode plate 11. If the ‘B’ exceeds 10 mm, the margin of the alignment is not increased any more, as compared with the case where the ‘B’ is 10 mm or less.

As described above, in a case where the negative electrode plate 13 is formed to have a size extended by 5 to 10 mm from each of the sides of the positive electrode plate 11, the difference in length between the positive electrode plate 11 and the negative electrode plate 13 positioned at the innermost position is different from that in length between the positive electrode plate 11 and the negative electrode plate 13 positioned at the outermost position. For example, the difference in length between the positive electrode plate 11 and the negative electrode plate 13 positioned at the innermost position is smaller than that in length between the positive electrode plate 11 and the negative electrode plate 13 positioned at the outermost position. This is provided by reflecting the thickness of the electrode assembly. As the electrode assembly reaches from the inside to the outside thereof, the difference in length between the negative and positive electrodes 13 and 11 occurs as large as the thickness of the electrode assembly.

For example, if the difference in length between the negative and positive electrode plates 13 and 11 is 10 mm, the difference in length between the positive electrode plate 11 and the negative electrode plate 13 positioned at the innermost position is about 10 mm. The difference in length between the positive electrode plate 11 and the negative electrode plate 13 positioned at the outermost position may be a value obtained by subtracting ½ of the thickness of the electrode assembly from 10 mm.

FIG. 7 is a perspective view showing a secondary battery including a housing according to the present embodiments.

Referring to FIG. 7, the secondary battery may further include a housing 20 that accommodates the electrode assembly 10 of FIG. 1. The housing 20 may comprise polypropylene (PP) or polyethylene terephthalate (PET).

One side of a positive electrode lead 21 and one side of a negative electrode lead 22 are exposed to the outside of the housing 20. Although not shown in this figure, the other sides of the positive and negative electrode leads 21 and 22 may be electrically connected to the positive and negative tabs 14 and 15, respectively.

The secondary battery according to the present embodiments may be applied to medium- and large-sized batteries or batteries for automobiles of 50 Ah or more. For example, the secondary may be applied to lead storage batteries for automobiles, batteries for uninterruptible power supply, batteries used for porclain excavators or excavators, and the like.

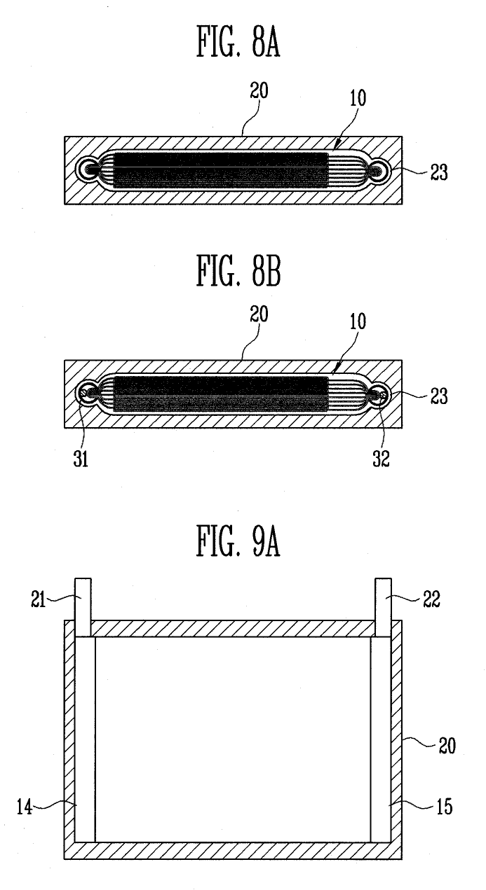

FIG. 8A is a cross-sectional view taken along line C-C′ of FIG. 7.

Referring to FIG. 8A, a space portion 23 is formed in the inside of the housing 20, so that the electrode assembly 10 can be accommodated in the space portion 23. In this instance, the space portion 23 may be formed to have a shape identical to the external appearance of the electrode assembly 10.

FIG. 8B is another cross-sectional view taken along the line C-C′ of FIG. 7.

Referring to FIG. 8B, a positive electrode auxiliary terminal 31 and a negative electrode auxiliary terminal 32 may be further formed between the positive electrode tab 14 and the positive electrode plate 11 and between the negative electrode tab 15 and the negative electrode plate 13, respectively. In this instance, the positive and negative electrode auxiliary terminals 31 and 32 may be electrically connected to the positive and negative electrode leads 21 and 22, respectively. The positive and negative electrode tabs 14 and 15 may be electrically connected to the positive and negative electrode auxiliary terminals 31 and 32 through welding, respectively.

For example, the positive electrode auxiliary terminal 31 functions to electrically connect the positive electrode tab 14 and the positive electrode lead 21 to each other, and the negative electrode auxiliary terminal 32 functions to electrically connect the negative electrode tab 15 and the negative electrode lead 22 to each other. Although not shown in this figure, the positive and negative electrode auxiliary terminals 31 and 32 may be substituted for the respective positive and negative electrode leads 21 and 22 when the positive and negative electrode auxiliary terminals 31 and 32 are formed to protrude to the outside of the housing 20.

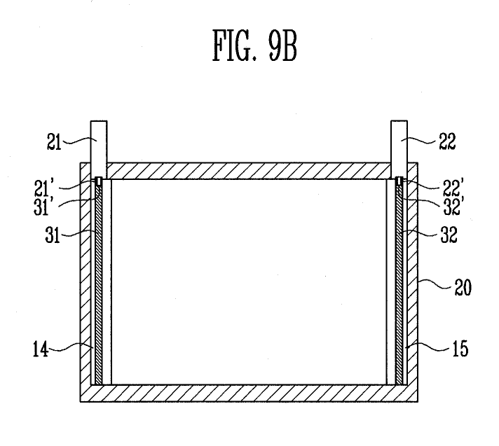

FIG. 9A is a sectional view taken along line D-D′ of FIG. 7.

Referring to FIG. 9A, one sides of the positive and negative electrode leads 21 and 22 are exposed to the outside of the housing 20, and the other sides of the positive and negative electrode leads 21 and 22 are connected to the positive and negative electrode tabs 14 and 15, respectively. Here, the positive electrode tab 14 and the positive electrode lead 21 may be electrically connected to each other, and the negative electrode tab 15 and the negative electrode lead 22 may be electrically connected to each other. The electrical connection may be performed through resistance welding.

FIG. 9B is a sectional view taken along the line D-D′ of FIG. 7.

Referring to FIG. 9B, the positive and negative electrode auxiliary terminals 31 and 32 are formed between the positive electrode tab 14 and the positive electrode plate 11 and between the negative electrode tab 15 and the negative electrode plate 13, respectively. In this instance, the positive and negative electrode tabs 14 and 15 may be connected to the positive and negative electrode auxiliary terminals 31 and 32 through resistance welding, respectively. The positive and negative electrode auxiliary terminals 31 and 32 may be electrically connected to the positive and negative electrode leads 21 and 22 through resistance welding or screw bonding, respectively.

In a case where the positive and negative electrode auxiliary terminals 31 and 32 are screw-bonded to the respective positive and negative electrode leads 21 and 22, lower end portions of the positive and negative electrode leads 21 and 22 may be formed in the shapes of screws 21′ and 22′, respectively. The upper end portions of the positive and negative electrode auxiliary terminals 31 and 32 may be formed in the shapes of holes 31′ and 32′ having the screws 21′ and 22′ accommodated therein, respectively.

While the present embodiments have been described in connection with certain exemplary embodiments, it is to be understood that the embodiments are not limited to the disclosed embodiments, but, on the contrary, is intended to cover various modifications and equivalent arrangements included within the spirit and scope of the appended claims, and equivalents thereof.

What is claimed is:

1. A secondary battery comprising:
at least one first electrode plate having a first active material layer intermittently coated on a coating portion in the length direction thereof and a first non-coating portion on which the first active material layer is not coated, wherein the first non-coating portion is folded;
at least one second electrode plate alternately positioned with the first electrode plate, the second electrode plate having a second active material layer intermittently coated on a coating portion in the length direction thereof and a second non-coating portion on which the second active material layer is not coated, wherein the second non-coating portion is folded; and
separators positioned between the respective first and second electrode plates,
wherein the secondary battery further comprises a first electrode tab that clamps at least one of the first non-coating portions and a second electrode tab that clamps at least one of the second non-coating portions.

2. The secondary battery according to claim 1, wherein the first electrode tab comprises aluminum (Al), and the second electrode tab comprises nickel (Ni).

3. The secondary battery according to claim 1, wherein the first and second electrode tabs clamp the first and second non-coating portions in folded states with widths ranging from 40 to 95% with respect to the widths of the first and second non-coating portions, respectively.

4. The secondary battery according to claim 1, wherein the first and second electrode tabs are formed in a ‘C’ or ‘ [symbol] ’ shape.

5. The secondary battery according to claim 1, wherein the first and second electrode tabs are formed to have a thickness ranging from about 0.5 to about 1.0 mm.

6. The secondary battery according to claim 1, wherein the first and second electrode tabs are clamped to the respective first and second non-coating portions by applying pressure thereto.

7. The secondary battery according to claim 1, wherein the first electrode plate has a positive polarity, and the second electrode plate has a negative polarity.

8. The secondary battery according to claim 7, wherein the second electrode plate is larger than the first electrode plate.

9. The secondary battery according to claim 8, wherein, in the at least one first electrode plate and the at least one second electrode plate, the difference in length between the second electrode plate and the first electrode plate positioned at the innermost position is greater than the length between the second electrode plate and the first electrode plate positioned at the outermost position.

10. The secondary battery according to claim 1, wherein the separator is formed in a zigzag configuration, and is inserted between the first and second electrode plates from a direction perpendicular to the length directions of the first and second electrode plates.

11. The secondary battery according to claim 1, wherein the separator is formed by coating an inorganic substance on the first and second electrode plates.

12. The secondary battery according to claim 1, wherein the separator is further formed on an outermost surface of each of the first and second electrode plates.

13. The secondary battery according to claim 1, further comprising a taping member formed on an outermost surface of each of the first and second electrode plates.

14. The secondary battery according to claim 1, further comprising a housing that accommodates the first and second electrode plates respectively clamped by the first and second electrode tabs and the separator.

15. The secondary battery according to claim 14, wherein the housing comprises at least one of polypropylene (PP) and polyethylene terephthalate (PET).

16. The secondary battery according to claim 15, further comprising first and second auxiliary terminals formed between the first electrode tab and the first electrode plate and between the second electrode tab and the second electrode plate, respectively, and the first and second auxiliary terminals are electrically connected to first and second electrode leads, respectively.

17. The secondary battery according to claim 16, wherein the first and second electrode tabs are electrically connected to the first and second auxiliary terminals through welding, respectively.

18. The secondary battery according to claim 16, wherein the first and second auxiliary terminals are electrically connected to the first and second electrode leads through screw bonding or welding, respectively.

19. The secondary battery according to claim 1, wherein the secondary battery is applied medium- and large-sized batteries of 50 Ah or more.

20. The secondary battery according to claim 18, wherein the secondary battery is applied medium- and large-sized batteries of 50 Ah or more.
